(19) United States
(12) Patent Application Publication
(10) Pub. No.: US 2007/0094317 A1
(43) Pub. Date: Apr. 26, 2007

(54) Method and system for B-spline interpolation of a one-dimensional signal using a fractional interpolation ratio

(75) Inventor: Minsheng Wang, Irvine, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/256,937

(22) Filed: Oct. 25, 2005

(51) Int. Cl. G06F 7/38

(52) U.S. Cl. 708/290

(57) ABSTRACT

The present invention provides systems, methods, and computer program products for performing fractional B-spline interpolation. The fractional B-spline interpolation system includes an upsampling module and a fractional B-spline interpolation filter. The B-spline interpolation filter calculates a set of B-spline interpolation coefficients at a plurality of fine index points using the second derivative of the B-spline base function. The number of B-spline interpolation coefficients in the set is equal to the number of polynomial segments comprising the B-spline base function. For each fine index point, each coefficient in a set of B-spline interpolation coefficients is multiplied by a corresponding original sampling point to generate the value of the interpolated signal at the fine index point. The B-spline interpolation filter also includes a memory for storing a set of initial values needed by the B-spline interpolation filter to calculate the B-spline interpolation coefficients.

### FIELD OF THE INVENTION

The present invention relates generally to interpolation of one-dimensional signals and specifically, to interpolation of one-dimensional signals using a fractional interpolation ratio.

### BACKGROUND

In signal processing, it is often necessary to increase the original sampling rate of a signal to a higher sampling rate. This process is referred to as up-sampling or interpolation. Certain applications require interpolation of a sampled signal using a fractional ratio. For example, in order to meet the audio Compact Disc standards (requiring a sampling rate of 44.1 kHz upsampled by a factor of 8 to a 352.8 kHz sampling rate), an audio signal originally sampled at 48 kHz must be interpolated to a higher frequency using a fractional ratio (e.g., 7.35). Conventional techniques for interpolating one-dimension (1-D) audio signals are limited to upsampling by integers.

Therefore, what is needed is a method and system for interpolating a 1-D signal using a fractional interpolation ratio.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 depicts a portion of an exemplary sampled input signal having a sampling period Tₛ.

FIG. 2 depicts an exemplary block diagram of an m+1^{th} order sinc filter with an interpolation ratio of R.

FIG. 3 depicts first, second, and third order B-spline functions.

FIG. 4 depicts an exemplary B-spline interpolation system for use in two dimensional image processing.

FIG. 5 depicts the convolution of a portion of exemplary input signal with a second-order interpolation function depicted in FIG. 3.

FIG. 6 depicts a flowchart of an exemplary method for interpolating an input signal using a fractional ratio.

FIG. 7 depicts a flowchart of an exemplary method for computing initial values to be used by the fractional B-spline interpolation system.

FIGS. 8A-C depicts the three segments of a second order B-spline base function and their second derivatives.

FIG. 9 depicts an exemplary cycle of computation.

FIG. 10 depicts a block diagram of an exemplary fractional B-spline interpolation system for use in 1-D signal processing.

FIG. 11 depicts a block diagram of an exemplary fractional B-spline interpolation filter for use in 1-D signal processing.

The present invention will now be described with reference to the accompanying drawings. In the drawings, like reference numbers generally indicate identical, functionally similar, and/or structurally similar elements.

The drawing in which an element first appears is indicated by the leftmost digit(s) in the reference number.

### DETAILED DESCRIPTION OF THE INVENTION

1. Overview

In signal processing, it is often necessary to increase the original sampling rate of a signal to a higher sampling rate. This process is referred to as up-sampling or interpolation. For example, for an audio signal originally sampled at 48 kHz, it may be necessary to up-sample the signal to a higher frequency in order to make it compatible with a specific standard (e.g., audio Compact Disc standards having a sampling rate of 44.1 kHz upsampled by a factor of 8 to 352.8 kHz). The present invention provides a system and method for using B-spline interpolation to perform fractional or rational interpolation of audio signals.

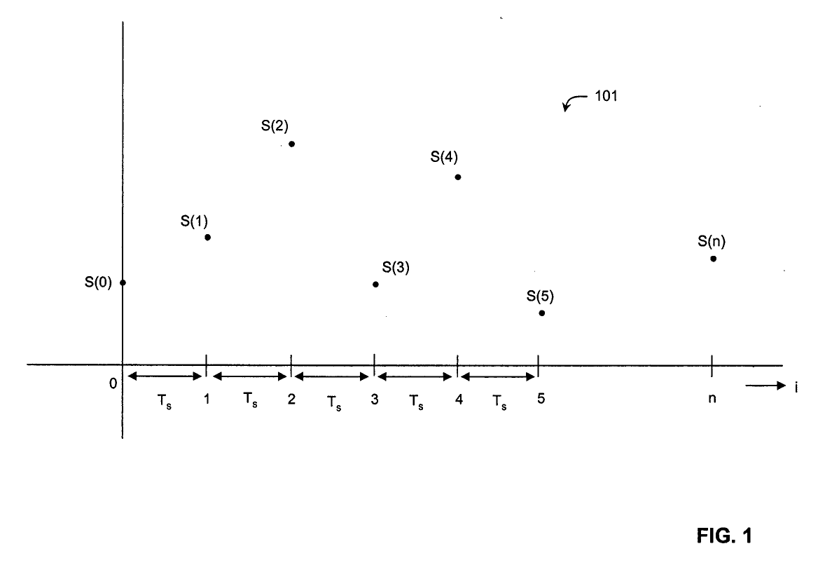

FIG. 1 depicts a portion of an exemplary sampled input signal 101 having a sampling period Tₛ. Index i represents the sampling point grid. As would be appreciated by persons of skill in the art, signal 101 could be any type of input signal sampled at any sampling rate. Signal 101 has a plurality of sample points s(0) through s(n).

Many techniques exist for up-sampling the sampled input signal 101.

For example, in zeroth order interpolation, the input signal is up-sampled by an integer (e.g., up-sampled by 4). When upsampling by four, three sampling points are added between two of the original sample points. The value of the added sampling points is the value of the first original sample point. Zeroth order interpolation is not optimal for many applications because it has unacceptable aliasing effects. Higher order interpolation (e.g., first order interpolation) is more effective.

1.1 Sinc Interpolation

Integer interpolation is widely used in one-dimensional (1-D) voice/audio signal processing. One common technique for performing integer interpolation uses sinc function interpolation. The sinc filter, also referred to as a comb filter, is one of the most effective digital interpolation/decimation filters used in signal processing. Sinc interpolation is essentially a running average technique. For example, in FIG. 1, if up-sampling by 2 is being performed, one point is added between two consecutive original sampling (e.g., s(0) and s(1)) points (as in zeroth order interpolation). Then, an average is taken by adding the neighboring two points and dividing the sum by two.

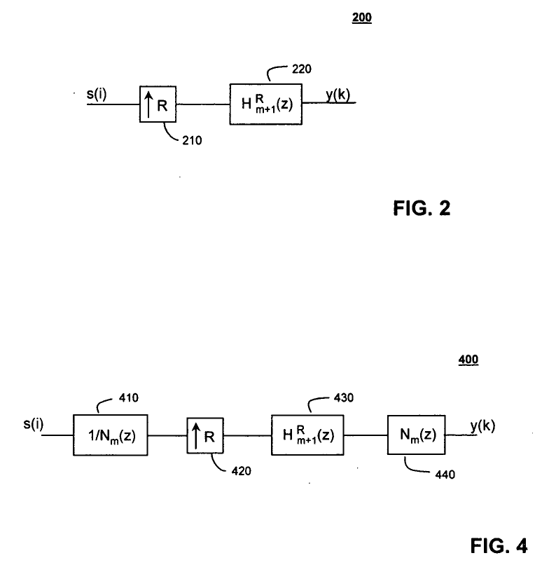

FIG. 2 depicts an exemplary block diagram of an m+1^{th} order sinc filter 200 with an interpolation ratio of R. Sinc filter 200 includes an up-sampling module 210 and a sinc filter 220. Equation (1) defines the transfer function of a sinc filter, such as shown in FIG. 2.

$${H}_{m}^{R} ( z ) = \frac{1}{{R}^{m}} ( \frac{1 - {z}^{- R}}{1 - {z}^{- 1}} )$$

Although sinc filters are commonly used in 1-D signal processing, sinc filters are limited to applications requiring up-sampling by an integer. Sinc function interpolation is not effective for fractional up-sampling ratios.
1.2 B-Spline Interpolation

Two dimensional (2-D) image processing typically uses spline functions for interpolation. Spline functions are basic building blocks used in signal analysis and reconstruction. In general, spline functions are piecewise polynomials joined together smoothly at knot points. An m^{th} order spline function, Nₘ(t) has polynomials of order m between the knot points. The degree of smoothness depends upon the order of the spline function.

B-spline functions have two prominent properties which make them valuable tools in signal processing. First, B-spline functions are compactly supported. FIG. 3 depicts a first order B-spline base function 310, a second order B-spline base function 320, and a third order B-spline base function 330, respectively. As can be seen in these figures, Nₘ(t) has compact support over [−(m+1)/2, (m+1)/2] with Nₘ((m+1)/2)=0. That is, Nₘ(t) is zero for |t|≧(m+1)/2. In signal processing, this means that only recent m data affect the output. Second, B-spline functions are m-1 times continuously differentiable at the knots. In other words, the m^{th}-derivative of Nₘ(t) is a piecewise constant.

A discrete signal s(k) can be represented by the B-spline base functions according to equation (2). Equation (3) represents the z-transform of equation (2). The coefficients of equation (3) may be determined by inverse filtering with the transfer function 1/Nₘ(z), as shown in equation (4a), below.

$$s ( k ) = {\sum }_{i ∈ Z} c ( i ) {N}_{m} ( k - i ) \qquad ( 2 )$$

S(z)=C(z)Nₘ(z) (3)
C(z)=S(z)/Nₘ(Z) (4a)
Equation (4a) can be implemented by an infinite impulse response (IIR) filter.

For example, for a quadratic B-spline (m=2), equation (4a) becomes:

$$C ( z ) = S ( z ) \frac{8}{z + 6 + {z}^{- 1}} = S ( z ) \frac{8 {z}_{1}}{( 1 - {z}_{1} {z}^{- 1} ) ( 1 - {z}_{1} z )} \\ where {z}_{1} = \sqrt{8} - 3 \qquad ( 4 b )$$

Interpolation of the original signal s(i) by a factor of R determines the discrete values as shown in equation (5) below.

$$s ( \frac{k}{R} ) = {\sum }_{i ∈ Z} c ( i ) {N}_{m} ( \frac{k}{R} - i ) \qquad ( 5 )$$

or in z-transform notation:
Sₘ(z)=C(z)Nₘ^{R}(Z) (6)
Nₘ^{R}(Z)=Nₘ(z)Hₘ₊₁^{R}(Z) (7)
Sₘ(z)=C(z)Nₘ(z)Hₘ₊₁^{R} (8)
As can be seen in equation (8), interpolating an m^{th} order B-spline by factor R is equivalent to convolving the function with an m+1^{th}-order sinc filter.

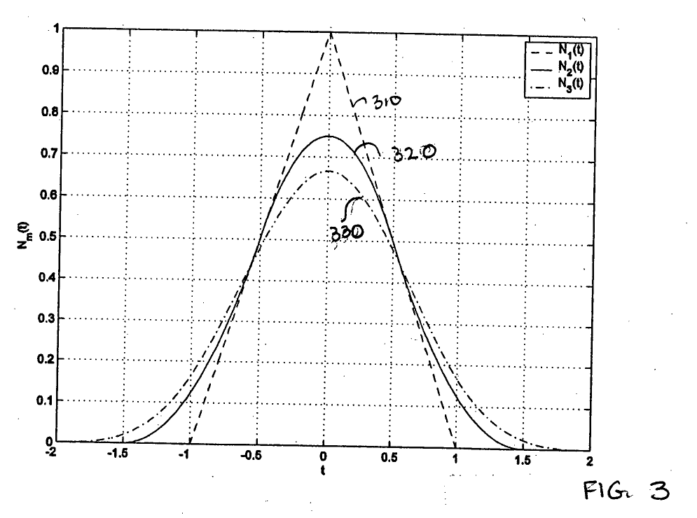

FIG. 4 depicts an exemplary B-spline interpolation system 400 used in two-dimensional (2-D) signal processing. Interpolation system 400 includes an inverse filter 410, an up-sampling module 420, m+1^{th}-order sinc filter 430, and a reconstruction filter 440. Input signal 402 is first passed through the inverse filter 410. Processing by inverse filter 410 produces a first set of analysis coefficients, c⁺(i), and a second set of analysis coefficients, c⁻(i). The analysis coefficients are used to weight the interpolation function. The resulting signal is then up-sampled by a factor of R by up-sampling module 420 and convolved with the sinc filter 430. The resulting signal is passed through the reconstruction filter 440.

Inverse filter 410 is a high-pass filter, which corrects the pass-band droop caused by the sinc filter and the reconstruction filter. The implementation of the inverse filter 410 increases the complexity of the B-spline interpolation system 400 of FIG. 4. The inverse filter 410 is an anti-causal filter. An anti-causal filter uses future data to generate present data.

Anti-causal filters are very good for applications using post-processing, off-line processing, or for applications that use already collected data. However, anti-causal filters are not efficient for use in real-time signal processing applications. The initial conditions required by equation (4b), for example, require extra hardware.

In addition, the interpolation system 400 is designed for perfect interpolation. In perfect interpolation, the interpolated samples are identical to the original samples s(i) at the knot points. Perfect interpolation is necessary for image interpolation because it minimizes image blurring.

1.2 B-Spline Interpolation in One-Dimensional Signal Processing

Perfect interpolation is not required for 1-D voice or audio interpolation. Requirements for voice or audio interpolation are primarily in the frequency domain, rather than in the time domain. For example, it is important to design an audio interpolation filter to meets certain specifications such as low pass-band ripple, sufficient stop-band attenuation, minimum image aliasing, and small group delay distortion, etc. Audio signals do not require the interpolated samples to be identical to the original samples at the knot points. Instead, what is required is that the signals be similar in the frequency domain. Because perfect interpolation is not required, the inverse filter defined in equation (4a) is unnecessary or can be replaced by a simple finite impulse response (FIR) filter in 1-D signal processing. Thus, the analysis coefficients, c⁺(i) and c⁻(i) are not required to perform the interpolation. Instead, the original sampled signal, s(i), is used instead of c(i).

As discussed above, the inverse filter 410 depicted in FIG. 4 is a high-pass filter which corrects the pass-band droop caused by the sinc filter 430 and the reconstruction filter 440. Other techniques exist for correcting the pass-band droop problem. For example, in voice and audio processing, a droop correction filter is also included to compensate for the aggregated pass-band droop caused by the sinc filter, the other filters, and the digital-to-analog converter. The droop correction filter is normally a simple causal FIR filter, and does not have the problems described above associated with the inverse filter 410 of FIG. 4. Therefore, in 1-D voice or audio processing, a simple causal FIR filter can be used instead of the expensive anti-causal IIR inverse filter. For ease of description, the droop correction filter is not discussed further herein.

In rational rate interpolation, the originally sampled signal s(i) (e.g., signal 101 of FIG. 1) is interpolated by up-sampling it by R and then convolving the original signal with an m^{th}-order B-spline function, dilated by R. The interpolated signal, y(k), is given by equation (9) below.

$$y ( k ) = s * {N}_{m}^{R} = {\sum }_{i ∈ Z} s ( i ) {N}_{m} ( \frac{k}{R} - i ) \qquad ( 9 )$$

where R is any rational number. Applying equations (7) through (9) yields:
Y(z)=S(z)Hₘ₊₁^{R}Nₘ (10)
In time-domain, equation (10) is represented as:
y(k)=s*h^{R}* . . . h^{R}*Nₘ (11)

As can be seen in equation (11), a strong relationship exists between sinc and spline interpolation. Equations (10) and (11) imply that the operation defined by equation (9) amounts to applying m+1^{th}-order sinc filter to the up-sampled input signal. In other words, convolving the up-sampled input signal with m^{th}-order R-dilated B-spline is equivalent to m+1^{th}-order sinc filter interpolation. While sinc interpolation is limited to integers, B-spline interpolation is not. When the interpolation ratio is an integer, the B-spline interpolation degenerates to sinc interpolation.

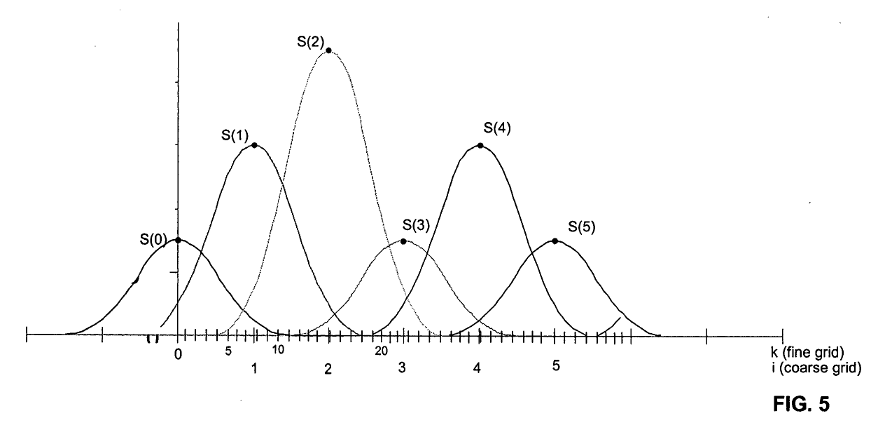

FIG. 5 depicts the convolution of a portion of exemplary input signal 101 with a second-order B-spline function 306 depicted in FIG. 3. FIG. 5 includes two indices on the horizontal axis. The first index, i, represents the original sampling point grid (also referred to as the coarse grid). The second index, k, represents the interpolated sampling point grid (also referred to as the fine grid). Because FIG. 5 represents a fractional interpolation, the number of interpolation points, k, between two original sampling points varies.

As can be seen in FIG. 5, for each value of k, the second-order B-spline functions associated with 3 consecutive original sampling points overlap. For example, at i=1 (or k=4 through 11), the B-spline functions associated with the S(0), S(1), and S(2) original sampling points overlap. At i=2 (or k=12 through 18), the B-spline functions associated with S(1), S(2), and S(3) original sampling points sampling points overlap. In accordance with equation (9), the interpolated signal, y(k), is given by summing the value of each overlapping function at k.

2. Method for Fractional Interpolation of 1-D Signal Using Spline Functions

The major computation in equation (9) for determining the value of the interpolation signal, y(k) is the evaluation of Nₘ for a given fractional ratio, R.

However, determining Nₘ directly from the continuous form, given in equation (9), is not efficient for certain types of applications. The method of the present invention instead obtains the interpolated signal, y(k), by integrating its m^{th} order derivative by m times. In addition, as described above, analysis coefficients c(i) are replaced with the value of the initial sampling point, s(i).

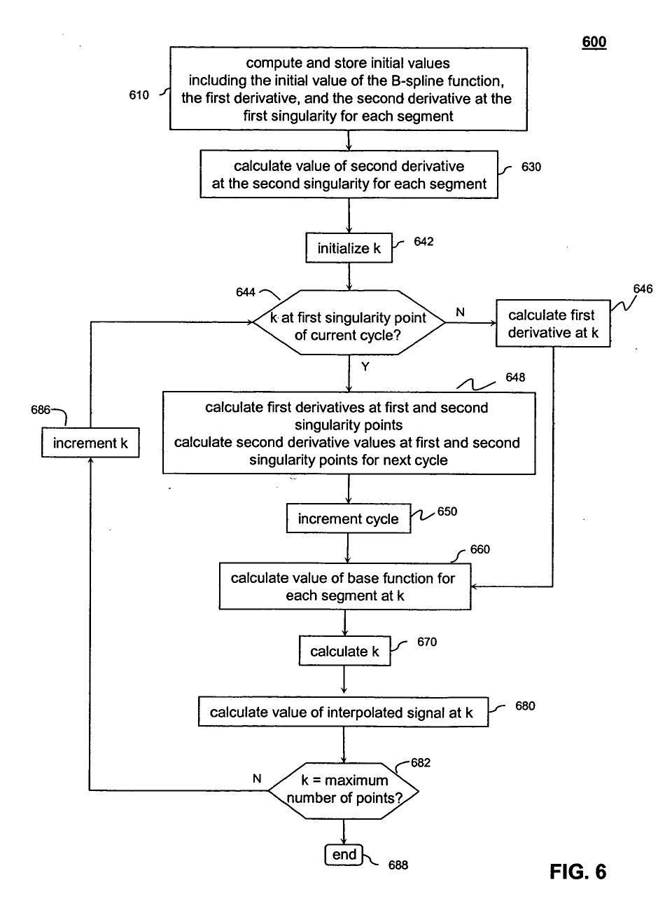

FIG. 6 depicts a flowchart 600 of an exemplary method for interpolating an input signal using a fractional ratio, according to an embodiment of the present invention. FIG. 6 is described with continued reference to the exemplary second order B-spline interpolation base function depicted in FIG. 3. However, FIG. 6 is not restricted to that embodiment. The method described below runs on a single processor, such as processor 1120 depicted in FIG. 11.

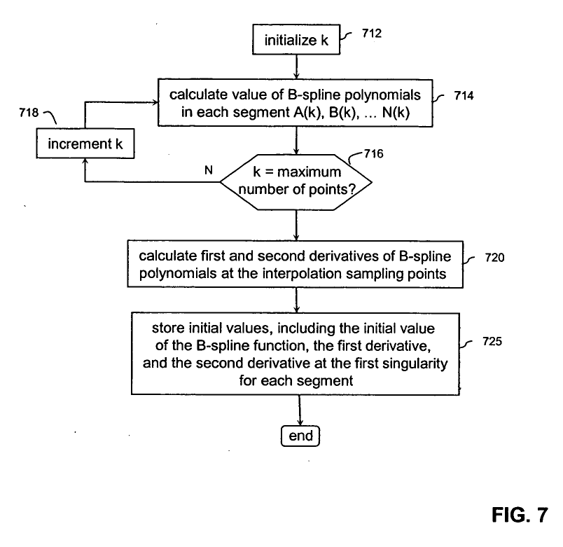

Flowchart 600 begins at step 610 when the initial values needed for real-time fractional B-spline interpolation are computed and stored. Step 610 is typically performed off-line. Step 610 is described in further detail below in FIG. 7.

In step 610, initial values for the m^{th} order B-spline base function, the first derivative of the m^{th} order B-spline base function, and the second derivative of the m^{th} order B-spline base function are computed and stored. In addition, in step 610, the variables k and i are initialized. The variable k represents the fractional interpolated sampling point grid. The variable i represents the original sampling point grid. The initial value of k may be determined by the following equation:

$$k = ⌈ \frac{R}{2} ⌉ ,$$

where R=interpolation ratio
The notation ┌x┐ means the ceiling of x, which is the smallest integer that is greater than or equal to x, for example, ┌7.35/2┐=4. The value for each knot point, Pᵢ, is also calculated in this step. Pᵢ corresponds to the indices of the knot points, which are the minimum positive integers that satisfy equation (12) below:

$$\frac{( ⌈ \frac{R}{2} ⌉ + {P}_{i} )}{R} \geq 1.5 + i \qquad ( 12 )$$

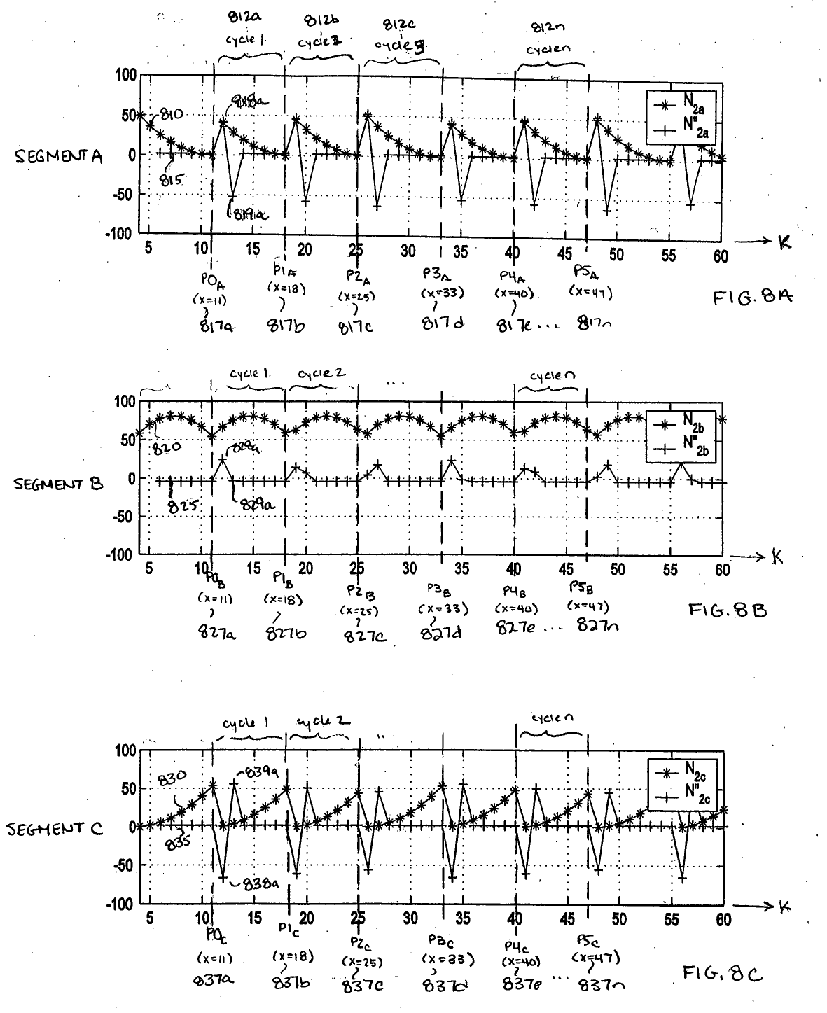

For example, according to equation (12), P₀=8, P₁=15, and P₂=22 for R=7.35. FIGS. 8A-C depict these knot points as P_{0A,B,C}=11, P_{1A,B,C}=18, and P_{2A,B,C}=25. Note that in FIGS. 8A-C the knot points are shifted by three interpolated sampling points.

As described above, an m^{th} order B-spline consists of m+1 polynomials joined together at the knot points. Flowchart 600 processes the B-spline base function in individual polynomial segments. This segmented approach is illustrated in FIGS. 8A-8C. Each cycle of FIG. 8A corresponds to N₂(t) in FIG. 3 with t between 0.5 and 1.5, FIG. 8B corresponds to N₂(t) in FIG. 3 with t between −0.5 and 0.5, and FIG. 8C corresponds to the N₂(t) in FIG. 3 with t between −1.5 and 0.5. FIG. 8A depicts segment A 810 of the B-spline base function and the second derivative of segment A 815 of the B-spline base function. A cycle of a segment 812a-n is the portion of the B-spline base function and/or second derivative function occurring between two knot points 817a-n. A segment includes multiple cycles during the interpolation process. As can be seen in FIG. 8A, the second derivative of the B-spline base function for segment A is constant during a cycle except at two singularity points. The first singularity point 818a occurs at the first interpolation sample after the knot point 817a. The second singularity point 819a occurs at the second interpolation sample after the knot point 817a.

FIG. 8B depicts segment B 820 of the B-spline base function and the second derivative of segment B 825 of the B-spline base function. As can be seen in FIG. 8B, the second derivative of the B-spline base function for segment B is constant during a cycle except at two singularity points. The two singularity points 828a and 829a occur at the same interpolation sampling points as the two singularity points of segment A.

FIG. 8C depicts segment C 830 of the B-spline base function and the second derivative of segment C 835 of the B-spline base function. As can be seen in FIG. 8C, the second derivative of the B-spline base function for segment C is constant during a cycle except at two singularity points. The two singularity points 838a and 839a occur at the same interpolation sampling points as the two singularity points of segments A and B.

When a fractional ratio is used, the number of interpolated sampling points between two knot points 817, 827, 837 varies per cycle. In the example of FIG. 8A, cycle 3 includes 8 interpolated sampling points whereas cycles 1 and 2 include 7 interpolated sampling points. Over the long term, the average number of sampling points per cycle approaches the fractional sampling rate 7.35. Further note, that the interpolated sampling points occur at different positions from cycle to cycle.

In the example of second order B-spline fractional ratio interpolation, the initial values computed and stored in step 610 include the following: initial value of the B-spline base function for each segment (e.g., value of 810, 820, and 830 at k=4), the initial value of first derivative of the B-spline base function for each segment, the second derivative of the first singularity 818a, 828a, 838a of the first cycle for each segment, and the constant value for the second derivatives for each segment.

Real-time fractional rate interpolation processing begins in step 630. In step 630, values for the second derivative of the first singularity point of the first segment cycle are retrieved and values for the second derivative at the second singularity for the first segment cycle are calculated. In the embodiment depicted in FIGS. 8A-8C, the values for the second derivative at the second singularity point are determined according to equations (13a)-(13c):
A″(2^{nd} singularity)=2*(2−R)−A″(1^{st} singularity) Segment A (13a)
B″(2^{nd} singularity)=−4*(2−R)−B″(1^{st} singularity) Segment B (13b)
C″(2^{nd} singularity)=2*(2−R)−C″(1^{st} singularity) Segment C (13c)
As can be seen in FIGS. 8A-C, the initial cycle begins at the initial value of k (e.g., k=4).

In step 644, a determination is made whether k is at the first singularity point (e.g., 817, 827, and 837) for the current cycle. If k is at the first singularity point for the current cycle, operation proceeds to step 648. If k is not at the first singularity point for the current cycle, operation proceeds to step 646. For example, in FIG. 8A-C, the first singularity point of the second derivative in cycle 2 occurs at k=12. Therefore, when k=12, operation proceeds to step 648. Otherwise, operation proceeds to step 646.

In step 646, the constant second derivatives are retrieved and the first derivatives of the base function are calculated for each segment at k. The first derivative is calculated by integrating the second derivative once. In an exemplary second order fractional interpolation system, the first derivatives are calculated according to equations (14a)-(14c):
A′(k)=A′(k−1)+A″(constant) segment A (14a)
B′(k)=B′(k−1)+B″(constant) segment B (14b)
C′(k)=C′(k−1)+C″(constant) segment C (14c)

In step 648, the first derivatives at the first and second singularity points of the cycle are determined for each segment. The first derivative is calculated by integrating the second derivative once. In an exemplary second-order fractional interpolation system, the first derivatives are determined using the following equations:
A′(1^{st} singularity pt)=A′(k−1)+A″(1^{st} singularity pt of current cycle) (15a)
A′(2^{nd} singularity pt)=A′(1^{st} singularity pt)+A″(2^{nd} singularity pt of current cycle) (15b)
B′(1^{st} singularity point)=B′(k−1)+B″(1^{st} singularity point of current cycle) (15c)
B′(2^{nd} singularity pt)=B′(1^{st} singularity pt)+B″(2^{nd} singularity pt of current cycle) (15d)
C′(1^{st} singularity point)=C′(k−1)+C″(1^{st} singularity point of current cycle) (15e)
C′(2^{nd} singularity pt)=C′(1^{st} singularity pt)+C″(2^{nd} singularity pt of current cycle) (15f)

In addition, in step 648, the first and second derivatives at the first and second singularity points for the next cycle are determined. The first and second derivatives may be given by the following equations:

$$\begin{matrix}{A}^{″} ( {1}^{st} singularity , next cycle ) = ( \frac{- ( {P}_{i + 1} - {P}_{i} )}{R} + 1 ) * 2 * {R}^{2} + {A}^{″} ( {1}^{st} singularity , current cycle ) & ( 16 a ) \\ {A}^{′} ( {1}^{st} singularity , next cycle ) = ( \frac{( {P}_{i + 1} - {P}_{i} )}{R} - 1 ) * 2 * {R}^{2} + {A}^{′} ( {1}^{st} singularity , current cycle ) & ( 16 b ) \\ {B}^{″} ( {1}^{st} singularity , next cycle ) = ( \frac{( {P}_{i + 1} - {P}_{i} )}{R} - 1 ) * 4 * {R}^{2} + {B}^{″} ( {1}^{st} singularity , current cycle ) & ( 16 c ) \\ {B}^{′} ( {1}^{st} singularity , next cycle ) = ( \frac{- ( {P}_{i + 1} - {P}_{i} )}{R} + 1 ) * 4 * {R}^{2} + {B}^{′} ( {1}^{st} singularity , current cycle ) & ( 16 d ) \\ {C}^{″} ( {1}^{st} singularity , next cycle ) = ( \frac{- ( {P}_{i + 1} - {P}_{i} )}{R} + 1 ) * 2 * {R}^{2} + {C}^{″} ( {1}^{st} singularity , current cycle ) & ( 16 e ) \\ {C}^{′} ( {1}^{st} singularity , next cycle ) = ( \frac{( {P}_{i + 1} - {P}_{i} )}{R} - 1 ) * 2 * {R}^{2} + {C}^{′} ( {1}^{st} singularity , current cycle ) & ( 16 f )\end{matrix}$$

In step 650, the cycle is incremented.

In step 660, the B-spline base function coefficient (e.g., A(k), B(k), . . . , N(k)) is calculated for each segment. The B-spline base function coefficient is calculated by integrating the first derivative once. In an exemplary second order fractional interpolation system, the value of the base function coefficient may be determined using equations (17a)-(17c):
A(k)=A(k−1)+A′(k−1) (17a)
B(k)=B(k−1)+B′(k−1) (17b)
C(k)=C(k−1)+C′(k−1) (17c)

In step 670, a set of original sampling points is identified. For an exemplary second order B-spline interpolation, the set of original sampling points includes three original sampling points, s(i−1), s(i), and s(i+1) where i represents the original sampling point grid. The value of i may be determined using equation (18):

$$i = ⌊ \frac{k}{R} - 0.5 ⌋ + 2 \qquad ( 18 )$$

The notation └x┘ means the floor of x, which is the largest integer that is less than or equal to x.

In step 680, the value for the interpolated signal is calculated at k. For the exemplary second order B-spline interpolation, the value of the interpolated signal is calculated using equation (19):
y(k)=A(k)*s(i−1)+B(k)*s(i)+C(k)*s(i+1) (19)
where s(i−1), s(i), and s(i+1) are original signal samples.

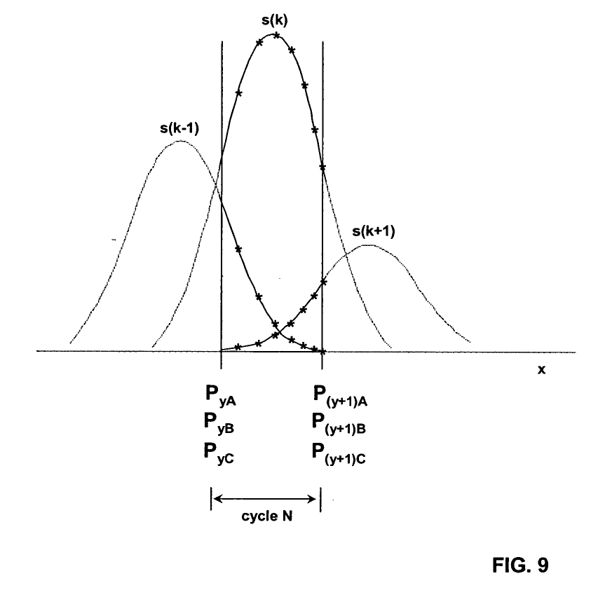

FIG. 9 depicts an exemplary cycle N. As can be seen in FIG. 9, the convolutions associated with three original sampling points s(i−1), s(i), and s(i+1) overlap. Specifically, segment A of the s(i−1) curve, segment B of the s(i) curve, and segment C of the s(i+1) curve overlap. The value of y(k) is the summation of the values of each of these curves at k.

In step 682, a determination is made whether k equals the maximum number of interpolation sampling points. If k equals the maximum number of interpolation sampling points, operation proceeds to step 688. If k does not equal the maximum number of interpolation sampling points, operation proceeds to step 686.

In step 686, k is incremented. Operation then returns to step 640.

In step 688, fractional rate interpolation processing ends.

FIG. 7 depicts a flowchart 700 of an exemplary method for interpolating an input signal using a fractional ratio. FIG. 7 is described with continued reference to the exemplary second order fractional B-spline interpolation depicted in FIG. 3 and 9A-C. However, FIG. 7 is not restricted to that embodiment.

FIG. 7 begins in step 712 when variable k is initialized. The variable k is an index representing the fractional interpolation sampling point grid. The initial value of k may be determined by equation (20):

$$k = ⌈ \frac{R}{2} ⌉ ,$$

where R=interpolation ratio (20)
For example, when the interpolation ratio equals 7.35, the initial value of k is 4.

In step 714, the value for each segment polynomial of the B-spline base function at k is calculated. In the second order B-spline interpolation example depicted in FIGS. 3 and 8A-8C, the value of the base function in each polynomial segment is given by equations (21a)-(21c):

$$\begin{matrix}A ( k - ⌈ \frac{R}{2} ⌉ + 1 ) = \frac{1}{2} {( \frac{3}{2} - \vert t \vert )}^{2} , \frac{1}{2} \leq \vert t \vert < \frac{3}{2} \\ where t = \frac{k}{R} - ⌊ \frac{k}{R} - 0.5 ⌋ segment A & ( 21 a ) \\ B ( k - ⌈ \frac{R}{2} ⌉ + 1 ) = - {t}^{2} + \frac{3}{4} , 0 \leq \vert t \vert < \frac{1}{2} \\ where t = \frac{k}{R} - 1 - ⌊ \frac{k}{R} - 0.5 ⌋ segment B \\ & ( 21 b ) \\ C ( k - ⌈ \frac{R}{2} ⌉ + 1 ) = \frac{1}{2} {( \frac{3}{2} - \vert t \vert )}^{2} , \frac{1}{2} \leq \vert t \vert < \frac{3}{2} \\ where t = \frac{k}{R} - 2 - ⌊ \frac{k}{R} - 0.5 ⌋ segment C & ( 21 c )\end{matrix}$$

FIGS. 8A-C illustrate the value of the base function for each segment polynomial. Note that the y-axis value is normalized by R² in FIGS. 8A-8C.

For example, at k=4, the value of the base function for segment A is 49.35; the value of the base function for segment B is 58.59 and the value of the base function for segment C is 0.11.

In step 716, a determination is made whether k equals the maximum number of interpolation sampling points. If k equals the maximum number of interpolation sampling points, operation proceeds to step 720. If k does not equal the maximum number of interpolation sampling points, operation proceeds to step 718.

In step 718, k is incremented. Operation then returns to step 714.

Steps 714 through 718 are repeated until the value of the base function is determined for each of the interpolation sampling points.

In step 720, values of the first and second derivatives of each segment are calculated for the interpolation sampling points. As can be seen in FIG. 8, the second derivative is constant in each segment, except at two singularity points 818, 819. Note that the first value of the second derivative occurs two interpolation sampling points after the first value of the B-spline function segment.

In step 725, initial values are stored. The initial values stored in step 725 include the following: initial value of the B-spline base function for each segment (e.g., value of 810, 820, and 830 at k=4), the initial value of the first derivative of the B-spline base function for each segment, the second derivative of the first singularity 817a, 827a, 837a of the first cycle for each segment, and the constant value for the second derivatives for each segment.

3.0 Structural Embodiments

The 1-D fractional B-spline interpolation system described below can be a component of a digital to analog converter or any digital system requiring the sampling rate to be changed by a fractional ratio.

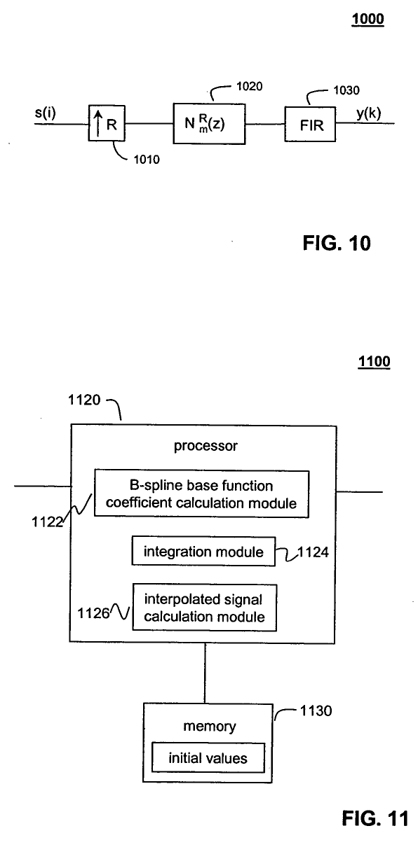

FIG. 10 depicts a 1-D fractional B-spline interpolation system 1000.

Interpolation system 1000 includes an up-sampling module 1010, a fractional B-spline interpolation filter 1020, and an optional finite impulse response (FIR) filter 1030. Fractional spline interpolation filter 1020 performs the method described above in FIG. 6. FIR filter 1030 operates as a droop correction filter. FIR filter 1030 is included in applications requiring correction of pass-band droop caused by the fractional spline interpolation filter 1030.

FIG. 11 depicts a block diagram of an exemplary fractional B-spline interpolation filter 1100 for use in 1-D signal processing. Fractional B-spline interpolation filter includes a processor 1120 and a memory 1130.

Processor 1120 includes a B-spline base function calculation module 1122, an integration module 1124, and an interpolated signal calculation module 1126. The B-spline base function calculation module 1122 determines the B-spline base function coefficients for each polynomial segment of the B-spline base function. For example, in the second order B-spline interpolation system, the B-spline coefficients are A(0), B(0), and C(0). The integration module 1124 performs the integration operations required by the system. The interpolation signal calculation module 1126 determines the value of the interpolated signal at the interpolated sampling points. For example, the calculation module 1126 multiples the set of B-spline coefficients by consecutive original sampling points. The calculation module 1026 then sums the results of the multiplications to obtain the value of the interpolated signal at the interpolated sampling point.

Memory 1130 stores the pre-computed initial values used by the processor 1120. The initial values may be computed by the processor 1120 off-line and stored in memory 1130. Alternatively, the initial values may be computed off-line by a separate processor and downloaded into memory 1130. Memory 1130 may be implemented as a register.

4.0 Conclusion

While various embodiments of the present invention have been described above, it should be understood that they have been presented by way of example, and not limitation. It will be apparent to persons skilled in the relevant arts that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A computer-implemented method for performing one-dimensional fractional B-spline interpolation, comprising:
(a) dividing a B-spline base function into a plurality of polynomial segments;
(b) for each segment,
(i) calculating initial values for a first cycle, wherein the initial values for the first cycle include a value of a B-spline base function coefficient at a first interpolated sampling point, a value of a first derivative of the B-spline base function at a second interpolated sampling point, a value of a second derivative of the B-spline base function at a first singularity point of the first cycle, and a constant value of the second derivative;
(ii) calculating a value of the second derivative at a second singularity point of the first cycle;
(iii) determining whether a first index point is at a first singularity point of the first cycle;
(iv) calculating the first derivative at the first index point if the first index point is not at the first singularity point;
(v) calculating values for the first derivative at the first and second singularity points of the first cycle and values for the second derivative at the first and second singularity points of the second cycle, if the first index point is at the first singularity point; and
(vi) calculating the B-spline base function coefficient at the first index point; and
(c) calculating a value of the interpolated signal at the first index point using the calculated B-spline base function coefficients and a set of original sampling points.

2. The method of claim 1, further comprising:
(d) repeating steps (b)(ii) through (c) for a plurality of index points.

3. The method of claim 1, further comprising integrating the second derivative at the first index point once to determine the first derivative at the first index point.

4. The method of claim 1, further comprising integrating the first derivative at the first index point once to determine the B-spline base function coefficient at the first index point.

5. The method of claim 1, wherein calculating a value for the interpolated signal at the first index point comprises:
identifying the set of original sampling points, wherein the number of sampling points in the set of original sampling points equals the number of polynomial segments; and
multiplying each original sampling point by a corresponding B-spline coefficient.

6. The method of claim 1, wherein calculating the initial values comprises:
for each segment,
calculating the value of the B-spline polynomial at a plurality of index points;
calculating a first derivative of the B-spline polynomial at the plurality of index points;
calculating a second derivative of the B-spline polynomial at the plurality of index points; and
storing a value of the B-spline polynomial at a first index point, a value of the first derivative of the B-spline polynomial at a second index point, and a value of the second derivative of the B-spline polynomial at the first singularity point of the first cycle.

7. The method of claim 6, wherein the initial values are computed off-line.

8. A computer program product comprising a computer useable medium including control logic stored therein, the control logic enabling the performance of one-dimensional fractional B-spline interpolation, comprising:
means for enabling a processor to divide a B-spline base function into a plurality of polynomial segments;
means for enabling the processor to calculate initial values for a first cycle, for each polynomial segment, wherein the initial values for the first cycle include a value of a B-spline base function coefficient at a first interpolated sampling point, a value of a first derivative of the B-spline base function at a second interpolated sampling point, a value of a second derivative of the B-spline base function at a first singularity point of the first cycle, and a constant value of the second derivative;
means for enabling the processor to calculate a value of the second derivative at a second singularity point of the first cycle, for each polynomial segment;
means for enabling the processor to determine whether a first index point is at a first singularity point of the first cycle, for each polynomial segment;
means for enabling the processor to calculate the first derivative at the first index point if the first index point is not at the first singularity point, for each polynomial segment;
means for enabling the processor to calculate, for each segment, values for the first derivative at the first and second singularity points of the first cycle and values for the second derivative at the first and second singularity points of the second cycle, if the first index point is at the first singularity point;
means for enabling the processor to calculate the B-spline base function coefficient at the first index point, for each polynomial segment; and
means for enabling the processor to calculate a value of the interpolated signal at the first index point using the calculated B-spline base function coefficients and a set of original sampling points.

9. The computer program product of claim 8, the control logic further comprising:
means for enabling the processor to repeat steps (b)(ii) through (c) for a plurality of index points.

10. The computer program product of claim 8, further comprising means for enabling the processor to integrate the second derivative at the first index point once to determine the first derivative at the first index point.

11. The computer program product of claim 8, further comprising means for enabling the processor to integrate the first derivative at the first index point once to determine the B-spline base function coefficient at the first index point.

12. The computer program product of claim 8, wherein the means for enabling the processor to calculate a value for the interpolated signal at the first index point comprises:
means for enabling the processor to identify the set of original sampling points, wherein the number of sampling points in the set of original sampling points equals the number of polynomial segments; and
means for enabling the processor to multiply each original sampling point by a corresponding B-spline coefficient.

13. The computer program product of claim 8, wherein the means for enabling the processor to calculate the initial values comprises:
means for enabling the processor to calculate the value of the B-spline polynomial at a plurality of index points;
means for enabling the processor to calculate a first derivative of the B-spline polynomial at the plurality of index points;
means for enabling the processor to calculate a second derivative of the B-spline polynomial at the plurality of index points; and
means for enabling the processor to store a value of the B-spline polynomial at a first index point, a value of the first derivative of the B-spline polynomial at a second index point, and a value of the second derivative of the B-spline polynomial at the first singularity point of the first cycle.

14. A fractional B-spline interpolation system, comprising:
an up-sampling module; and
a fractional B-spline interpolation filter coupled to the up-sampling module, wherein the fractional B-spline interpolation filter includes:
a B-spline base function coefficient calculation module configured to calculate the B-spline base function coefficients from a second derivative of the B-spline base function at a plurality of index points,
a integration module, and
an interpolated signal calculation module configured to multiply each coefficient in a set of B-spline base function coefficients by a corresponding original sampling point.

15. The system of claim 14, further comprising:
a droop correction filter coupled to the fractional B-spline interpolation filter.

16. The system of claim 14, wherein the fractional B-spline interpolation filter further includes a memory storing a plurality of initial values used by the B-spline base function coefficient calculation module.

17. The system of claim 16, wherein the initial values for the first cycle include a value of a B-spline base function coefficient at a first interpolated sampling point, a value of a first derivative of the B-spline base function at a second interpolated sampling point, a value of a second derivative of the B-spline base function at a first singularity point of the first cycle, and a constant value of the second derivative.

18. The system of claim 16, wherein the initial values are calculated in a processor external to the fractional B-spline interpolation filter.

19. The system of claim 14, wherein the interpolated signal calculation module is further configured to:
identify a set of original sampling points, wherein the number of original sampling points in the set of original sampling points equals the number of polynomial segments; and
multiply each original sampling point by a corresponding B-spline coefficient.
